(19) United States
(12) Patent Application Publication
(10) Pub. No.: US 2008/0090940 A1
(43) Pub. Date: Apr. 17, 2008

(54) Cold water-soluble and biodegradable ammunition

(76) Inventor: J. Patrick Epling, (US)

Correspondence Address: The Intellect Law Group, 2400 SE Federal Highway, Suite 340, Stuart, FL, 34994, US

(21) Appl. No.: 11/549,548

(22) Filed: Oct. 13, 2006

(51) Int. Cl. C08K 11/00; B28B 1/24

(52) U.S. Cl. 523/128; 425/542

(57) ABSTRACT

The product and method of manufacture of cold water-soluble and biodegradable ammunition for the improved environmental impact and safety of ammunition.

### FIELD OF THE INVENTION

This invention relates to the design and construction of novel, cold water-soluble and biodegradable ammunition for the improved environmental impact and safety of ammunition. The invention also relates to the product by process and method of manufacturing the cold water-soluble and biodegradable ammunition.

### BACKGROUND OF THE INVENTION

Biodegradable ammunitions are known in the prior art. Conventionally and ubiquitously, biodegradable ammunition have been made from polycaprolactone-based biodegradable plastic, and hydrolytically degradable, dioxaneone-based polymers, otherwise known as polydioxaneone, or nitrogen-containing analogues thereof, such as those disclosed in U.S. Pat. Nos. 5,859,090 and 6,025,458. During the development of the present invention, it was also realized that water-soluble and biodegradable ammunition could be formed from straight injection grade Polyvinylalcohol (“PVA”).

However, the disadvantage to these types of ammunitions, including the ammunition formed from regular injection grade Polyvinylalcohol, is that it is difficult to obtain the correct weight of the ammunition. The processing times also slow down and the post molding processing becomes more complicated and costly as a result of these materials. Moreover, the shelf life performance of ammunition formed from these materials is not optimal. Clearly there is a need for water-soluble and biodegradable ammunition that will remedy the disadvantages attributable to the prior art.

### SUMMARY OF THE INVENTION

The inventive structure presents a number of advantages over the prior art. First, the invention is environmentally friendly. Cold water-soluble and biodegradable ammunition will dissolve when it contacts water thus reducing litter problems associated with Acrylonitrile Butadiene Styrene “ABS,” Polypropylene “PP,” and Polyethylene “PE” ammunition. The cold water-soluble and biodegradable ammunition can be rinsed away with regular yard watering or natural rainwater. The cold water-soluble and biodegradable ammunition also will not clog sewers and treatment systems due to its cold water-soluble and biodegradable characteristics. Finally, the dissolvable nature of the ammunition reduces or eliminates its potential danger to wildlife that might ingest the plastic.

Another distinct advantage of the cold water-soluble and biodegradable ammunition is safety. In the preferred embodiment, the properties of formulation prevent the ammunition from shattering upon impact, and therefore, the ammunition is much safer to use because it does not produce plastic shards, which can cause eye damage.

The cold water-soluble and biodegradable ammunition material formulation and processing method of the present invention also remedies the prior art problems, including obtaining the ammunition's optimal weight, quicker processing times and less complicated, less costly post mold processing, and improved shelf life performance.

As mentioned earlier, during the development of the present invention, it was realized that water-soluble and biodegradable ammunition may be formed from straight injection grade Polyvinylalcohol. However, the straight injection grade Polyvinylalcohol exhibited the same problems associated with the other prior art materials. Thus, it became necessary to improve the straight injection grade Polyvinylalcohol for those reasons discussed.

In order to overcome some of these problems that occur during the material formulation process, the present invention blended the Polyvinylalcohol with a cold water-soluble starch to improve the melt flow characteristics of the straight Polyvinylalcohol. The starch also helps reduce the ambient moisture absorption rate, which improves the shelf life and process handling issues associated with the prior art and the straight Polyvinylalcohol.

Cold water-soluble filler, such as calcium carbonate, is added. The cold water-soluble filler is added to overcome the ammunition weight issue that occurs with the prior art and the straight Polyvinylalcohol. The cold water-soluble filler also improves the shear characteristics of the Polyvinylalcohol so that the post molding processing is easier and less costly. Colorant may be added. The colorant also helps improve the weight as well as the shear properties of the Polyvinylalcohol. Lastly, the cold water-soluble and biodegradable material used to form the ammunition is then processed. It may be packaged in a sealed container and sent off to material processing.

In order to overcome some of the prior art problems that occur during material processing and post mold processing, the present invention utilizes injection molding equipment and a modified tooling design for the improved blended material.

The standard set up conditions for the prior art ABS ammunition were not satisfactory to process the new cold water-soluble compound. The tool gate size needs to be altered, namely the diameter needs to be made smaller, to allow the ammunition to be separated from the runner much easier. A restricted tool gate may also be built, which will allow the ammunition to be separated directly from the mold. A restricted tool gate is a very small orifice between the runner and cavity in an injection mold. When the part is ejected, this gate readily breaks free of the runner system. Generally, the part drops through one chute and the runner system through another leading to a granulator and scrap reclaim system.

The size of the runner and orientation of the ammunition to the runner needs to be altered to ensure the proper filing of each of the ammunition cavities. In the preferred embodiment, the runner is wider and shorter toward the edge of the tool than in the prior art standard set up.

Next, the ammunition is separated from the runner, preferably through the use of an auger or rotary separators in a controlled environment with reduced speeds to ensure the temperature of the ammunition does not get too hot and cause the ammunition to become tacky. Then the ammunition is placed in a mechanical tumbler, preferably a media type tumbler without water to de-burr the ammunition. Traditional methods utilize standard water media tumbling equipment to de-burr the ammunition, but due to the cold water-soluble characteristics of the present invention a media type tumbler without water must be used to prevent the ammunition from dissolving.

Lastly, the ammunition is packaged, preferably with moisture sealed lid and moisture vapor plastic to ensure stability of the product during shipment.

### BRIEF DESCRIPTION OF THE DRAWINGS

FIG. 1 is a flowchart describing the method of material formulation and material processing.

FIG. 2. is a layout of the tool designs used in the prior art.

FIG. 3. is a layout of the tool design according to the specifications contained herein.

### DETAILED DESCRIPTION OF THE INVENTION

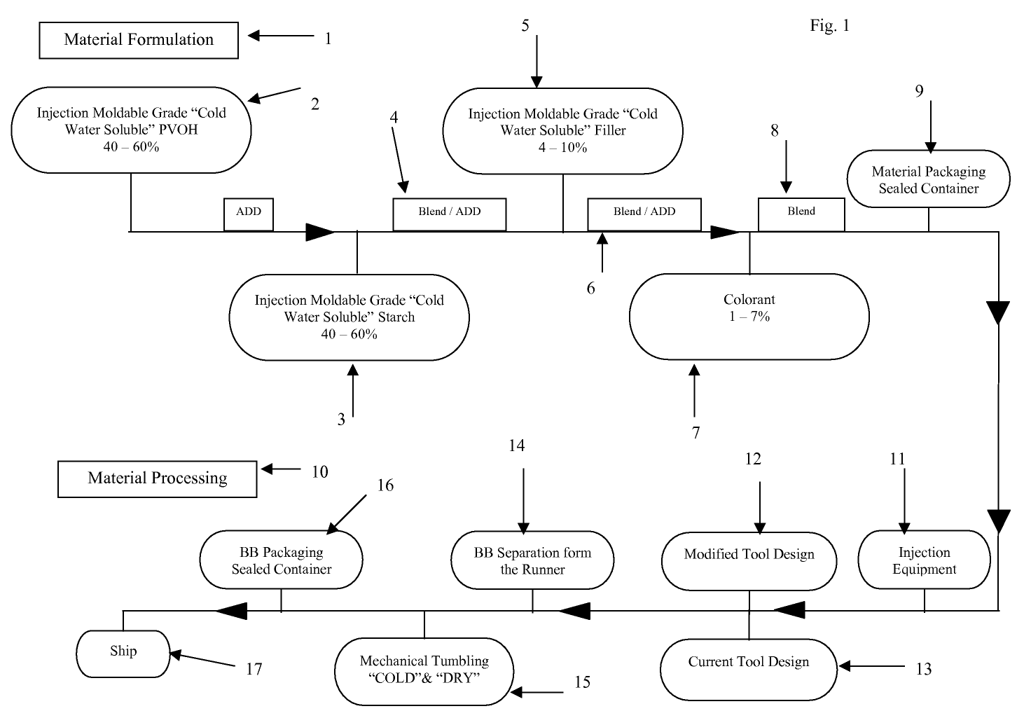

Shown in FIG. 1 is a flowchart describing the method of material formulation and material processing of the cold water-soluble and biodegradable ammunition. During the material formulation process (1), injection moldable grade cold water-soluble polyvinylalcohol, within the preferred range of not less than 40% and not more than 60%, (2) is combined wit a cold water-soluble starch, within the preferred range of about 40% to about 60%, (3) and then blended (4) to improve the melt flow characteristics of the straight Polyvinylalcohol. The starch also helps reduce the ambient moisture absorption rate, which improves the shelf life and process handling issues associated with the prior art and the straight Polyvinylalcohol.

Next, cold water-soluble filler, within the preferred range of about 4% to about 10%, is added (5) and then blended (6) with the other materials. The cold water-soluble filler is added to overcome the ammunition weight issue that occurs with the prior art and the straight Polyvinylalcohol. The cold water-soluble filler also improves the shear characteristics of the Polyvinylalcohol so that the post molding processing is easier and less costly. Next, colorant is added, within the preferred range of about 1% to about 7% (7) and blended (8) with the other materials. The colorant also helps improve the weight as well as the shear properties of the Polyvinylalcohol. Lastly, the cold water-soluble and biodegradable material used to form the ammunition is packaged in a sealed container (9) and sent off to material processing (10).

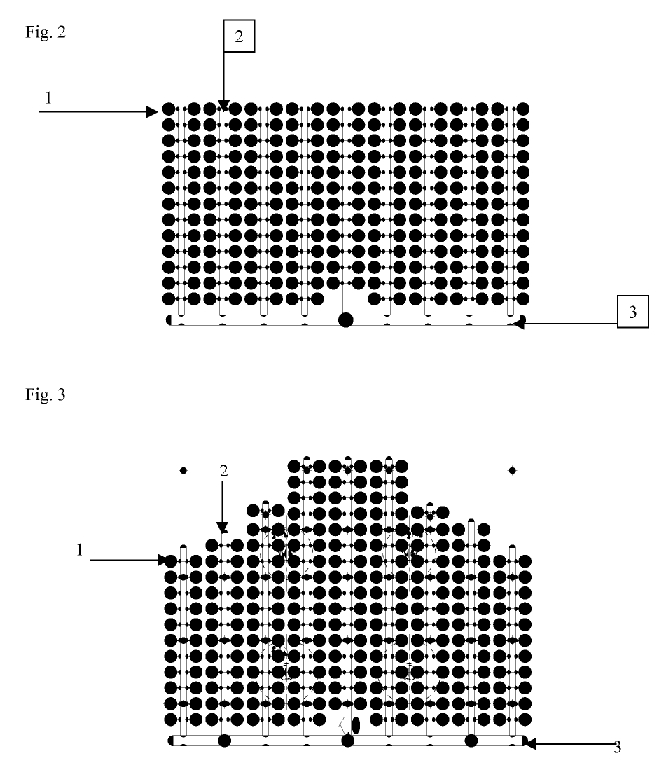

The material can then be processed to form the ammunition through the use of injection molding equipment (11). The present invention utilizes a modified tool design (12), as shown in detail in FIG. 3, wherein the runner is wider and shorter toward the edge of the tool as opposed to the prior art tool design (13), as shown in detail in FIG. 2.

Referring now to FIG. 2, the BB cavity (1) and the runner (2) are all the same height. In the modified design reflected in FIG. 3, the center runners (2) are lengthened and the outer runners are shortened to allow the water soluble blend to flow and fill the BB cavity (1) at the far edges of the tool. The same or similar number of BB cavities per modified tool as exemplified in FIG. 3 is maintained when compared with the prior art tools exemplified in FIG. 2 to keep the price down and the output up. The runners (2) and (3) are greater in diameter thereby allowing more material to flow to the BB cavity (1), ensuring proper fill. Next, the ammunition is separated from the runner (14), preferably through the use of an auger or rotary separators in a controlled environment with reduced speeds to ensure the temperature of the ammunition does not get too hot and cause the ammunition to become tacky. Then the ammunition is placed in a cold mechanical tumbler (15), preferably a media type tumbler without water to de-burr the ammunition. Traditional methods utilize standard water media tumbling equipment to de-burr the ammunition, but due to the cold water-soluble characteristics of the present invention a media type tumbler without water must be used to prevent the ammunition from dissolving.

Lastly, the ammunition is packaged (16), preferably with moisture sealed lid and moisture vapor plastic to ensure stability of the product during shipment (17).

What is claimed is:

1. A cold water-soluble and biodegradable material for forming ammunition comprising:
injection moldable grade cold water-soluble Polyvinylalcohol;
injection moldable grade cold water-soluble starch; and
injection moldable grade cold water-soluble filler.

2. The material of claim 1 combined with a colorant.

3. A biodegradable material for forming ammunition comprising:
injection moldable grade Polyvinylalcohol;
injection moldable grade starch;
injection moldable grade filler.

4. The material of claim 3 combined with a colorant.

5. The method of forming a cold water-soluble and biodegradable material comprising the steps of:
taking injection moldable grade cold water-soluble Polyvinylalcohol of about 40% to about 60%;
adding injection moldable grade cold water-soluble starch of about 40% to about 60%; and
blending the polyvinylalcohol with the starch;
adding injection moldable grade cold-water soluble filler of about 4% to about 10%;
blending the polyvinylalcohol and starch with the filler;
adding colorant of about 1% to about 7%;
blending the polyvinylalcohol, starch and filler with the colorant; and
packaging the material in a sealed container.

6. The method as described in claim 5 wherein the polyvinylalcohol is not less than 40% and not more than 60%.

7. The method as described in claim 5 wherein the injection moldable grade cold-water soluble starch is not less than 40% and not more than 60%.

8. The method as described in claim 5 wherein the injection moldable grade cold-water soluble filler is not less than 4% and not more than 10%.

9. The method as described in claim 5 wherein the colorant is not less than 1% and not more than 7%.

10. A method of processing the material described in claim 2 to form cold water-soluble and biodegradable ammunition comprising the steps of:
placing the material in an injection-molding device wherein the injection-molding device includes a tool gate size of about 0.03 to 0.05 mm separating the ammunition from the runner;
tumbling the ammunition in a cold mechanical tumbler;
packaging the ammunition in a sealed container.

11. A method of processing the material described in claim 10 further comprising:
placing the material in an injection-molding device wherein the injection-molding device includes a runner which is not less than 5 mm wide and not more than 200 mm in length at the tool edge.

12. A method as described in claim 10 wherein the step of separating the ammunition from the runner is accomplished through the use of an auger.

13. A method as described in claim 10 wherein the step of separating the ammunition from the runner is accomplished through the use of a rotary separator.

14. A device for injection molding including a tool gate of a diameter of not more than 0.03 to 0.05 mm
A device for injection molding including a runner which is not less than 2 mm wide and not more than 3.5 mm in length at the tool edge.
